(19) United States
(12) Patent Application Publication
(10) Pub. No.: US 2016/0210566 A1
(43) Pub. Date: Jul. 21, 2016

(54) SAVING TRACKER SYSTEM AND METHOD

(71) Applicants: BIKASH MOHANTY, MUMBAI (IN); NIMISH VORA, MUMBAI (IN)

(72) Inventors: BIKASH MOHANTY, MUMBAI (IN); NIMISH VORA, MUMBAI (IN)

(21) Appl. No.: 15/082,928

(22) Filed: Mar. 28, 2016

Related U.S. Application Data
(63) Continuation-in-part of application No. 13/236,650, filed on Sep. 20, 2011.

(30) Foreign Application Priority Data
Jul. 15, 2011 (IN) 2032/MUM/2011

(51) Int. Cl. G06Q 10/06

(52) U.S. Cl. CPC G06Q 10/063

(57) ABSTRACT

Systems and methods for the analysis of cost saving in a procurement process are provided. The systems include a processor unit and a computer readable medium. The computer readable medium stores instructions executable by the processor unit. The instructions are programmed to perform the steps of receiving baseline cost information, receiving purchase cost information, and computing a plurality of components of cost saving. Moreover, the instructions are programmed to transfer an indication of the computed components of the cost saving to a display device and/or a financial accounting system.

### CROSS-REFERENCE TO RELATED APPLICATIONS

The present invention is a continuation-in-part of U.S. patent application Ser. No. 13/236,650, filed Sep. 20, 2011, pending, and claims priority to Indian Patent Application Serial No. 2032/MUM/2011, filed Jul. 15, 2011, the entire specifications of both of which are expressly incorporated herein by reference.

### FIELD OF THE INVENTION

The present invention is generally related to the function of procurement of goods and services in organizations.

### BACKGROUND OF THE INVENTION

In many organizations, the procurement department procures goods and services for the various business units or business functions within the organization. Merely as examples, goods and services procured can include physical items such as raw material, fuel, product components, etc. Also merely as examples, goods and services procured can include other items such as freight capacity, advertising time, Internet bandwidth, legal services, etc.

The procurement cost is often an important aspect of the overall operational efficiency and/or the financial bottom line of the organization. Accordingly, the procurement departments and/or professionals are often incentivized to reduce the procurement cost. The reduction in procurement cost is also called as “cost saving.” The saving attained is often indicative of performance of the procurement departments/professionals. The cost saving also impacts organization's financial accounts. It thus becomes desirable to provide techniques for detailed analysis of cost saving attained in the procurement process.

### SUMMARY OF THE INVENTION

It is an object of the present invention to provide system and method for the detailed analysis of cost saving attained in the procurement of goods and services in the organization. While the cost saving could simply mean the amount of money saved, there are several components of the cost saving in the context of the procurement process. These different components have different implications in terms of gauging performance of the procurement departments/professionals, impact of cost saving on organization's profit and loss, impact of cost saving on organizations operational capacity/efficiency, etc. It thus becomes essential to be able to effectively track these various components of the cost saving, so that they can be properly accounted for. The present invention provides techniques for this purpose.

The techniques according to the present invention can advantageously facilitate analysis of the various components of the cost saving. For example, by practicing the present invention, it becomes possible to separate that component of cost saving which has material impact on the financial balance sheet from another component which is indicative of the performance of the procurement department. As yet another example, it becomes possible to separate that component of cost saving which is achieved at the expense of reduced consumption from another component which is indicative of effective negotiation with the supplier.

Moreover, in an embodiment, the present invention provides the saving tracker system that is based on readily available computing technologies. The embodiment utilizing these computing technologies can also facilitate tracking of cost saving in complex, large volume and/or large diversity procurement processes. It also facilitates ready integration with other business functions such as financial accounting, forecasting, procurement performance monitoring, etc.

In a specific embodiment of the present invention, a computer based system for tracking cost saving in a procurement process is provided. The system comprises a processor unit. Moreover, the system comprises a computer readable medium storing instructions, which are executable by the processor unit. The instructions are programmed to perform the steps of receiving an input identifying a stage within a procurement process for a selected goods and/or service item, receiving an input associated with baseline cost information for the selected item, receiving an input associated with purchase price information for the selected item. Moreover, the instructions are programmed to perform the steps of identifying a plurality of components for cost saving, computing the plurality of the components for the cost saving based at least upon the baseline cost information and the purchase cost information, and transferring indication of the plurality of the components for the cost saving which are computed. In alternative embodiments, associated methods for tracking cost saving in a procurement process are also provided.

In a specific embodiment of the present invention, a computer based system is provided for tracking cost saving in a procurement process, wherein there is an interconnection of at least one configurable and namable business process element, comprising:

a host computer system including a computer processor unit;

a display device operably associated with the computer processor unit;

a communication interface for accessing the host computer system from a plurality of remote input/output devices to manage analysis of the cost saving of the procurement process;

and

a computer readable medium operably associated with the computer processor unit, the computer readable medium storing instructions executable by the computer processor unit to perform the steps of:

receiving an input identifying a stage within a procurement process for a selected goods or service item;

receiving an input associated with baseline cost information for the selected item;

receiving an input associated with purchase price information for the selected item;

identifying a plurality of components for cost saving;

computing the plurality of the components for the cost saving, based at least upon the baseline cost information and the purchase cost information; and

transferring an indication of the computed plurality of the components for the cost saving;

wherein the indication of the computed plurality of the components for the cost saving corresponds to a performance level of a procurement department that executes the procurement process;

wherein the plurality of the components for the cost saving includes a plurality of benefit type components;

wherein the plurality of the benefit type components includes a cost reduction component and a cost avoidance component;

wherein the plurality of the components of the cost saving includes a plurality of impact type components that are indicative of a plurality of reasons for the cost saving;

wherein the plurality of the impact type components includes a cost saving component due to a decrease in quantity and a cost saving component due to a decrease in price, wherein the cost saving component due to a decrease in price corresponds to a negotiation by the procurement department of a lower price for the selected item.

In accordance with one aspect of this embodiment, the transferring of the indication of the plurality of the components for the cost saving comprises transferring the indication to the display device.

In accordance with one aspect of this embodiment, the transferring of the indication of the plurality of the components for the cost saving comprises transferring the indication to a computer based financial accounting system for incorporation in financial accounts.

In accordance with one aspect of this embodiment, the computing of any of the plurality of the components for the cost saving utilizes a pre-configured formula for that component.

In accordance with one aspect of this embodiment, the plurality of the components for the cost saving relates to a plurality of heads in the financial accounts.

In accordance with one aspect of this embodiment, the stage within the procurement process comprises a stage selected from the group consisting of a forecast stage, a negotiation stage, a contract stage, and a purchase stage.

In another specific embodiment of the present invention, a computer implemented method is provided for tracking cost saving in a procurement process, wherein there is an interconnection of at least one configurable and namable business process element, comprising:

providing a host computer system including a computer processor unit;

providing a display device operably associated with the computer processor unit;

providing a communication interface for accessing the host computer system from a plurality of remote input/output devices to manage analysis of the cost saving of the procurement process;

providing a display device operably associated with the computer processor unit;

providing a computer readable medium operably associated with the computer processor unit, the computer readable medium storing instructions executable by the computer processor unit to perform the steps of:

receiving an input identifying a stage within a procurement process for a selected goods or service item;

receiving an input associated with baseline cost information for the selected item;

receiving an input associated with purchase price information for the selected item;

identifying a plurality of components for cost saving;

computing the plurality of the components for the cost saving, based at least upon the baseline cost information and the purchase cost information; and

transferring an indication of the computed plurality of the components for the cost saving;

wherein the indication of the computed plurality of the components for the cost saving corresponds to a performance level of a procurement department that executes the procurement process;

wherein the plurality of the components for the cost saving includes a plurality of benefit type components;

wherein the plurality of the benefit type components includes a cost reduction component and a cost avoidance component;

wherein the plurality of the components of the cost saving includes a plurality of impact type components that are indicative of a plurality of reasons for the cost saving;

wherein the plurality of the impact type components includes a cost saving component due to a decrease in quantity and a cost saving component due to a decrease in price.

In accordance with one aspect of this embodiment, the transferring of the indication of the plurality of the components for the cost saving comprise transferring the indication to the display device.

In accordance with one aspect of this embodiment, the transferring of the indication of the plurality of the components for the cost saving comprise transferring the indication to a computer based financial accounting system, wherein the plurality of the components for the cost saving relates to a plurality of heads in the financial accounts.

In accordance with one aspect of this embodiment, the stage within the procurement process comprises a stage selected from the group consisting of a forecast stage, a negotiation stage, a contract stage, and a purchase stage.

In still another specific embodiment of the present invention, a computer based system is provided for tracking cost saving in a procurement process, wherein there is an interconnection of at least one configurable and namable business process element, comprising:

a host computer system including a computer processor unit;

a display device operably associated with the computer processor unit;

a communication interface for accessing the host computer system from a plurality of remote input/output devices to manage analysis of the cost saving of the procurement process;

and

a computer readable medium operably associated with the computer processor unit, the computer readable medium storing instructions executable by the computer processor unit to perform the steps of:

receiving an input identifying a stage within a procurement process for a selected goods or service item;

receiving an input associated with baseline cost information for the selected item;

receiving an input associated with purchase price information for the selected item;

identifying a plurality of components for cost saving;

computing the plurality of the components for the cost saving, based at least upon the baseline cost information and the purchase cost information; and

transferring an indication of the computed plurality of the components for the cost saving;

wherein the indication of the computed plurality of the components for the cost saving corresponds to a performance level of a procurement department that executes the procurement process;

wherein the plurality of the components for the cost saving includes a plurality of benefit type components;

wherein the plurality of the benefit type components includes a cost reduction component and a cost avoidance component;

wherein the plurality of the components of the cost saving includes a plurality of impact type components that are indicative of a plurality of reasons for the cost saving;

wherein the plurality of the impact type components includes a cost saving component due to a decrease in quantity and a cost saving component due to a decrease in price, wherein the cost saving component due to a decrease in price corresponds to a negotiation by the procurement department of a lower price for the selected item;

wherein the transferring of the indication of the plurality of the components for the cost saving comprises transferring the indication to the display device.

In yet another specific embodiment of the present invention, a computer implemented method is provided for tracking cost saving in a procurement process, wherein there is an interconnection of at least one configurable and namable business process element, comprising:

providing a host computer system including a computer processor unit;

providing a display device operably associated with the computer processor unit;

providing a communication interface for accessing the host computer system from a plurality of remote input/output devices to manage analysis of the cost saving of the procurement process; and

providing a computer readable medium operably associated with the computer processor unit, the computer readable medium storing instructions executable by the computer processor unit to perform the steps of:

receiving an input identifying a stage within a procurement process for a selected goods or service item;

receiving an input associated with baseline cost information for the selected item;

receiving an input associated with purchase price information for the selected item;

identifying a plurality of components for cost saving;

computing the plurality of the components for the cost saving, based at least upon the baseline cost information and the purchase cost information; and

transferring an indication of the computed plurality of the components for the cost saving;

wherein the indication of the computed plurality of the components for the cost saving corresponds to a performance level of a procurement department that executes the procurement process;

wherein the plurality of the components for the cost saving includes a plurality of benefit type components;

wherein the plurality of the benefit type components includes a cost reduction component and a cost avoidance component;

wherein the plurality of the components of the cost saving includes a plurality of impact type components that are indicative of a plurality reasons for the cost saving;

wherein the plurality of the impact type components includes a cost saving component due to a decrease in quantity and a cost saving component due to a decrease in price, wherein the cost saving component due to a decrease in price corresponds to a negotiation by the procurement department of a lower price for the selected item;

wherein the transferring of the indication of the plurality of the components for the cost saving comprises transferring the indication to the display device.

In still yet another specific embodiment of the present invention, a system for analysis of cost saving in a procurement process is provided, wherein there is an interconnection of at least one configurable and namable business process element, comprising:

a host computer system;

at least one database component associated with the host computer system;

a communication interface for accessing the host computer system from a plurality of remote input/output devices to manage analysis of cost saving in a procurement process, wherein the business process element includes:

receiving an input through an input/output system;

identifying a stage or transaction tracking within the procurement process for a selected good or service item on a web based form;

receiving an input associated with baseline cost information for the selected item based on the integration of the system with a spend analysis system;

receiving an input associated with purchase price information for the selected item for a procurement stage based on an integration of a procurement system;

identifying a plurality of components for cost saving;

computing the plurality of the components for the cost saving, based at least upon the baseline cost information and purchase cost information; and

flipping of the web based form containing baseline information and purchase information for the procurement stage into an electronic report including a cost saving analysis transferring an indication of a computed plurality of the components for the cost saving;

wherein a plurality of benefit type components includes a cost reduction component;

wherein the plurality of the components of the cost saving includes a plurality of impact type components that are indicative of a plurality of reasons for the cost saving;

wherein the plurality of the impact type components includes a cost saving component due to a decrease in quantity and a cost saving component due to a decrease in price that are indicative of a plurality of reasons for the cost saving;

wherein the plurality of the components for the cost saving includes a plurality of benefit type components;

wherein the plurality of the components of the cost saving include a plurality of impact type components that are indicative of a plurality of reasons for the cost saving;

wherein the plurality of the impact type components include a cost saving component due to a decrease in quantity and a cost saving component due to a decrease in price;

wherein the cost saving component due to a decrease in price corresponds to a negotiation by the procurement department of a lower price for the selected item.

For example, the user could manage an element of the system and method for managing the analysis of cost saving in a procurement process on the handheld mobile device (e.g., cellular phone, smartphone, PDA, laptop computer, tablet computer, and/or any other like device that is selectively operable to communicate with the host computer system (or component thereof) through a wired and/or wireless connection) for which management needs to be done for.

These and other various objects, features, advantages, and benefits of the present invention can be more fully appreciated with reference to the detailed description and accompanying drawings that follow.

### BRIEF DESCRIPTION OF THE DRAWINGS

Embodiments of the present invention are illustrated in the figures of the accompanying drawings. The figures are provided to aid thorough understanding of the invention and are exemplary rather than limiting. Based on the present teachings, person of ordinary skill in the art can contemplate various alternatives, variations and modifications to the illustrated embodiments within the scope of the invention disclosed herein.

FIG. 1 illustrates an exemplary computer network environment appropriate for a specific embodiment of the present invention;

FIG. 2 illustrates an exemplary computer apparatus that can provide a computing platform to practice specific embodiments of the present invention;

FIG. 3 illustrates an exemplary schematic of a system for cost saving analysis according to a specific embodiment of the present invention;

FIG. 4 illustrates an exemplary flow of steps in a method for cost saving analysis according to a specific embodiment of the present invention; and

FIGS. 5A, 5B, 6A and 6B illustrate exemplary computer screenshots illustrating certain cost saving analyses, according to embodiments of the present invention.

### DETAILED DESCRIPTION OF THE INVENTION

The present invention is generally related to the function of procurement of goods and services in organizations. The procurement departments and/or professionals are often incentivized to reduce the procurement cost. The cost reduction of procurement is often called as cost saving.

While the cost saving could simply mean the amount of money saved, there are several components of the cost saving in the context of the procurement process. These different components have different implications in terms of gauging performance of the procurement departments/professionals, impact of cost saving on organization's profit and loss, impact of cost saving on organizations operational capacity/efficiency, etc. It thus becomes desirable to be able to effectively track these various components of the cost saving, so that they can be properly accounted for. The present invention provides techniques for this purpose.

Described below in more detail, are certain exemplary components of cost saving.

Cost reduction: This component typically reflects directly on the profit and loss of the organization. It also reflects on the performance of the procurement function.

Cost avoidance: This component typically reflects on the performance of the procurement function in terms of avoiding anticipated cost increase.

Quantity reduction vs price reduction: This component typically attributes the reason for cost saving to change in the consumption volume and/or change in price of procurement.

Merely to facilitate understanding of such different components of cost saving, the following examples are provided. These examples are illustrative, rather than limiting.

### Example 1

In this example, suppose that the organization needs 10 units of certain item to be procured during a certain time period, say each year. Suppose the organization purchases 10 units at $10 each during year 2010, but expects the prices to go up to $13 in the year 2011. Suppose that the procurement function negotiates with the supplier much earlier in the year 2010 and manages to get 10 units for year 2011 at a price of $9 per unit. In this case, the cost saving (cost avoidance) due to early negotiation is 10×$3=$30 and the cost reduction is 10×$1=$10.

### Example 2

In the above scenario, suppose that the procurement team negotiates with the supplier in the year 2010 and manages to get 10 units for year 2011 at a price of $11 per unit. In this case, the cost saving (cost avoidance) due to early negotiation is 10×$2=$20 and the negative cost reduction (or increase in cost) is 10×$1=$10.

### Example 3

In this example, suppose that the organization has set a baseline cost of one unit of item as $10, which for example can be current reasonable price in the market. Further suppose that the organization needs 10 units of this item to operate during a certain time period, say each year. In the year 2011, suppose the procurement purchases 20 items at $9 each, because the supplier agrees to give $1 discount on each item if at least 20 are purchased. Then, the cost saving due to effective negotiation is 10×$1=$10, and negative cost saving (or increased cost) due to volume increase is 10×$9=$90.

### Example 4

In the above example, suppose that the procurement purchases only 5 items at $9 each, because of decreased consumption need. Then, the cost saving due to effective negotiation is 10×$1=$10, and cost saving due to volume decrease is 5×$9=$45.

The components of cost saving such as cost reduction, cost avoidance, etc. are often called as benefit type of cost saving. The components of cost saving related to changes in quantity, quantity, etc. are often called as impact type of cost saving.

As can be seen, it is desirable to properly account for different components of the cost saving in a procurement process. The techniques according to the present invention advantageously facilitate tracking various components of cost saving in procurement process, for example, vis-a-vis their relevance to the organization. For example, by practicing the present invention, it becomes possible to separate that component of cost saving which has material impact on the balance sheet from another component which is indicative of the performance of the procurement department. As yet another example, it becomes possible to separate that component of cost saving which is achieved as a result of reduced consumption from another component which is indicative of effective negotiation with the supplier.

The specific embodiments of the present invention are described below in greater detail. The following description of the specific embodiments refers at various places to the accompanying drawings and specific environments, applications, platforms, examples, computer screenshots, and implementations. Such description is provided for thorough understanding of the present invention and is illustrative rather than limiting.

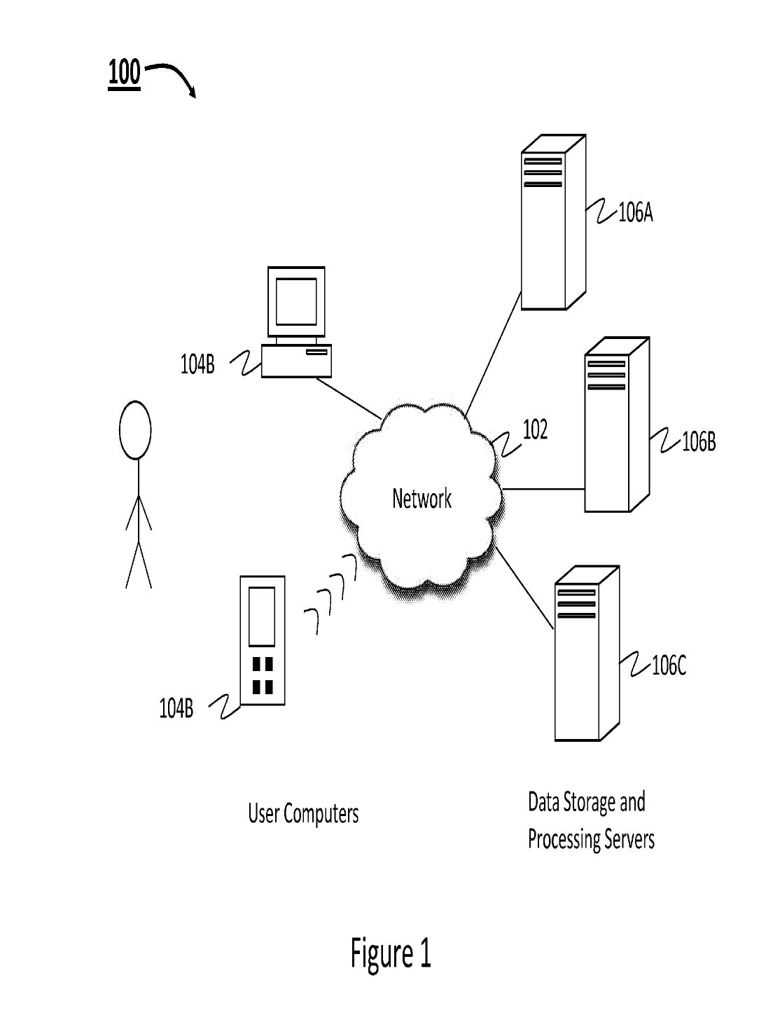

FIG. 1 illustrates an exemplary networked computer system 100 which can provide an environment to practice certain specific embodiments of the present invention. As shown in FIG. 1, multiple end user computer systems 104 and multiple server computer systems 106 can be coupled to a computer network 102. For example, the computer network 102 can be a private network of the organization. In alternative embodiment, the computer network 102 can include the local area network (LAN); and in yet an alternative embodiment it can include the Internet. The end user computer systems 104 can include without limitation desktop computers, laptop computers, personal digital assistant (PDAs), tablets, and smart phones. The computer systems 104, 106 etc. can exchange information using the computer network 102.

The servers 106 store digitized content which can be accessed (e.g., read, downloaded, searched, changed etc. as appropriate) over the computer network. A specific portion of the content is often identified using a hyperlink. The content stored in one server can also be accessed by another server and by the end user computer system. Popular techniques for accessing the content include HTTP and (HyperText Transfer Protocol) and HTTPS (HypterText Transfer Protocol Secure), though other techniques can also be used. Access to some portions of the content may require authentication and/or authorization for access.

Depending upon embodiments of the present invention, the servers 106 and the computer systems 104 can be configured to perform certain acts. For example, the servers 106 and the computer systems 104 can include software which can facilitate performing these acts. These acts can include various acts performed by the “user interaction module”, by the “cost saving analysis module”, by the “spend management module”, and by the “financial accounting module”. The acts can also include various acts for interaction between these modules.

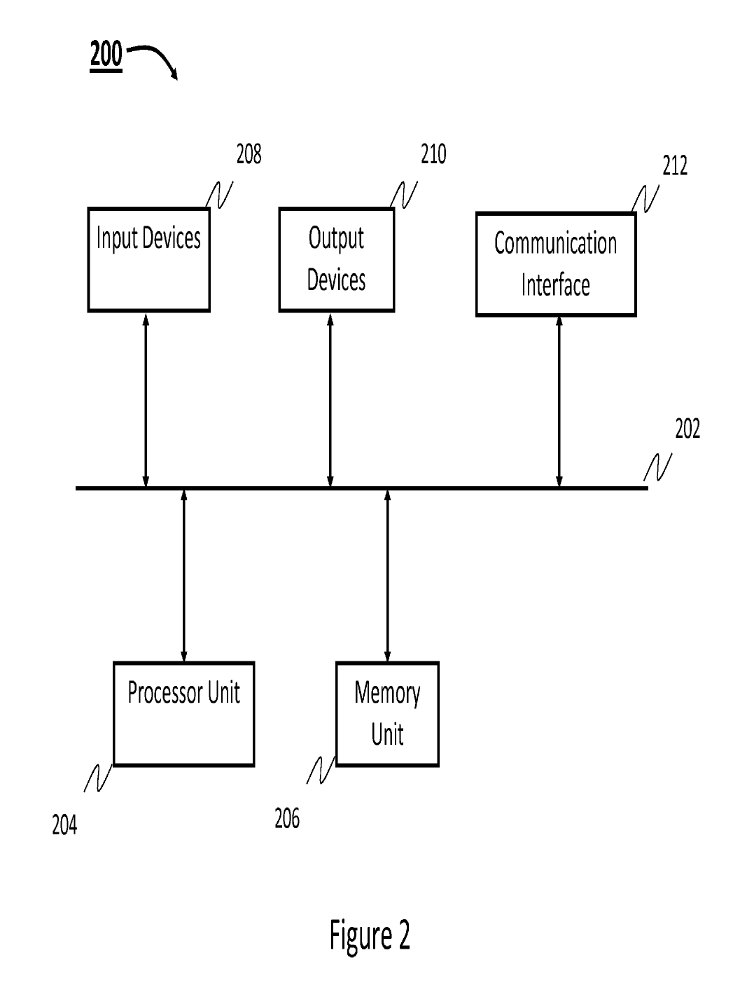

FIG. 2 illustrates an exemplary implementation of any of the servers 106 or any of the end user computer system 104, according to an embodiment of the present invention. The bus 202 permits communication among the components. The processor unit 204 may include one or more microprocessors, microcontrollers, RISC processors, CISC processors etc. The processor unit can interpret and execute instructions. The memory unit 206 may include any type of one or more volatile storage devices, for example, random access memory (RAM). The memory unit 206 may in addition or alternatively include any type of one or more persistent storage devices, for example read only memory (ROM), read write memory, hard disc, flash memory etc. The memory unit stores information and instructions for execution by the processor unit 204.

The input devices 208 may include one or more mechanisms that permit an operator to input information, such as a keyboard, mouse, pen, magnetic drives, optical drives etc. The output devices 210 may include one or more mechanisms that output information to the operator, including a display, a printer, a speaker etc. The communication interface 212 may include any transceiver mechanism that enables communication with other devices and systems via a network. For example, the communication interface can include Ethernet interface, optical network interface, wireless interface etc.

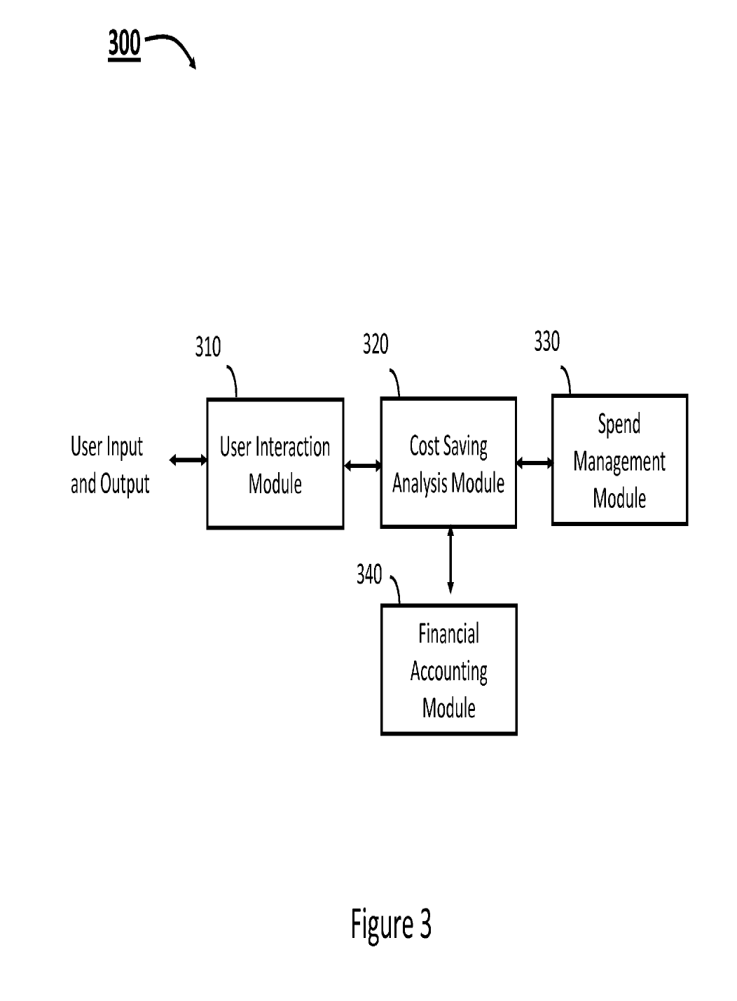

FIG. 3 illustrates an exemplary schematic 300 of a system for saving tracking according to an embodiment of the present invention. As shown in FIG. 3, the system 300 comprises various modules. Each of these modules can be a hardware module, a software module, or combination thereof. Moreover, depending upon the embodiment, each of the modules can reside on a single computer system or can be distributed across a plurality of interconnected computers. The user interaction module 310 provides interface between user and machine, and performs acts such as receiving input from user and providing output to the user. The spend management module 330 typically stores procurement information, such as past procurement records. The saving analysis module 320 can perform various acts associated with analyzing the cost saving. The financial accounting module 340 can perform various acts associated with balance sheet preparation, profit and loss statement preparation, etc.

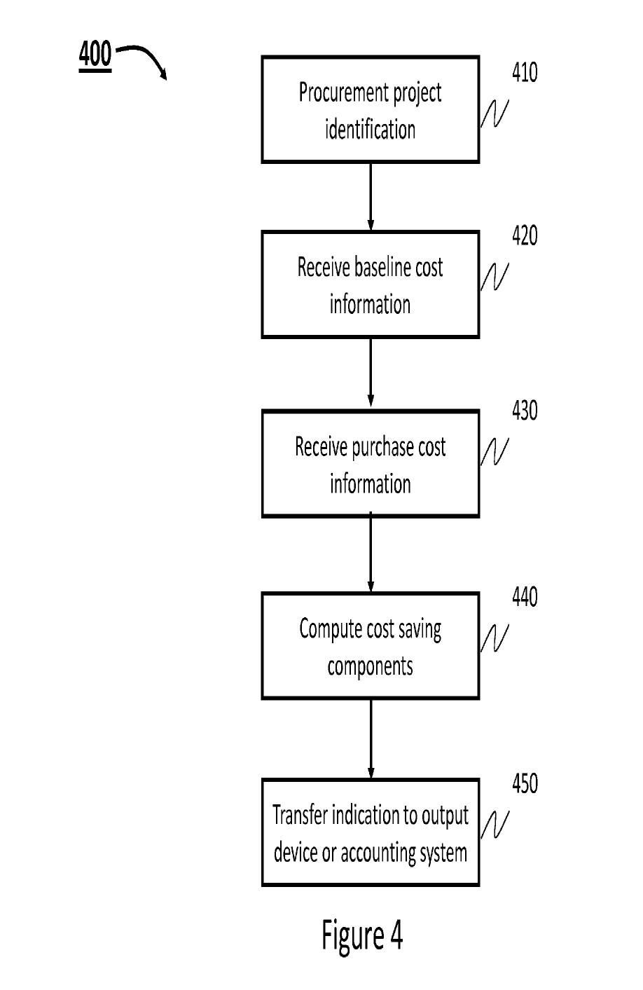

A flowchart 400 illustrating exemplary cost saving analysis process according to an embodiment of the present invention is shown in FIG. 4. For example, the process as illustrated in FIG. 4 can be performed utilizing the systems of FIGS. 1-3. At step 410, the method 400 can accept procurement project identification information such as title, description, owner, duration, start time, end time, currency, type of item(s) to be sourced, their quantity and quality, etc. According to an embodiment of the present invention which utilizes computer apparatus, the method can accept such information by way of input from the user in a computer screen (for example, as facilitated by the user interaction module 310).

Further at step 420, the method can accept baseline cost information associated with the item(s) identified in step 410. The baseline cost information serves as a reference based on which the cost saving components can be computed. The baseline cost information can be generated based upon any of the appropriate criteria such as current reasonable price in the market, average of historical prices, the commodity index, anticipated price in future, etc. According to an embodiment of the present invention which utilizes computer apparatus, the method can accept the baseline cost information by way of input from the user in a computer screen (for example, as facilitated by the user interaction module 310).

At step 430, the method can accept actual or negotiated purchase cost information associated with the item(s) identified in step 410. In an embodiment, the purchase cost information can be received from the spend management module 330 which stores procurement records. In an alternative embodiment, the purchase cost information can be provided by user via the user interaction module 310.

At step 440, the method computes one or more components of cost saving. In an embodiment, the method can accept user input specifying the one or more cost saving components to be computed. The computation can be based upon pre-configured or user supplied formulas.

Moreover, at step 450, the method can transfer information associated with the cost saving components to display device, printer device, or another computer system such as computer based financial accounting system.

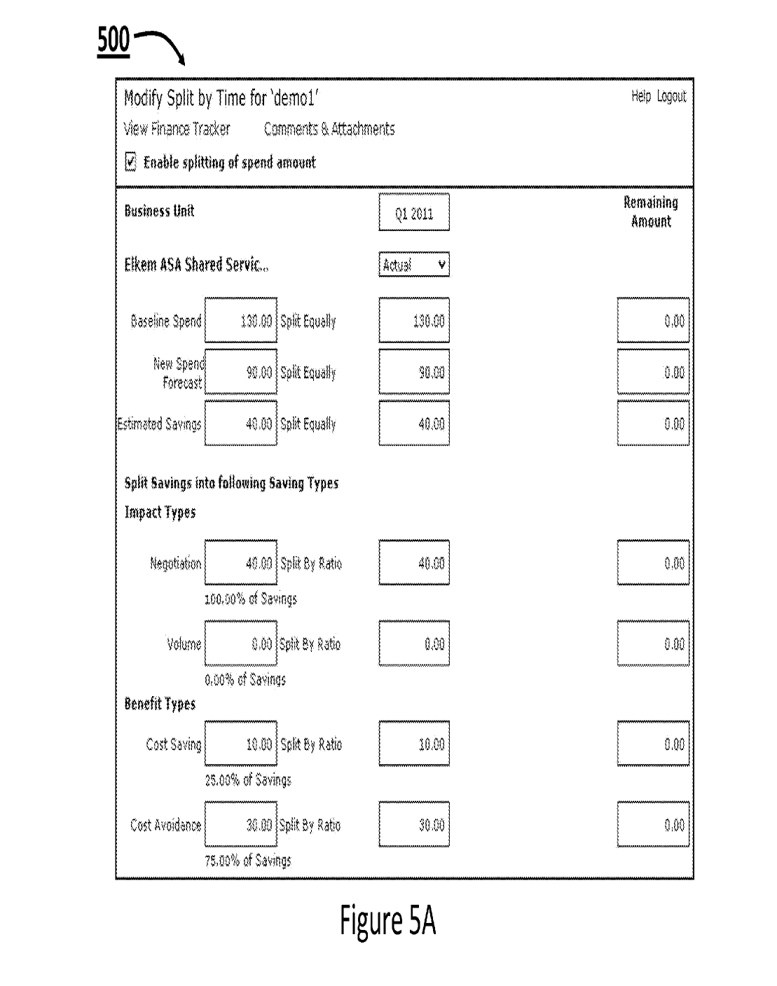

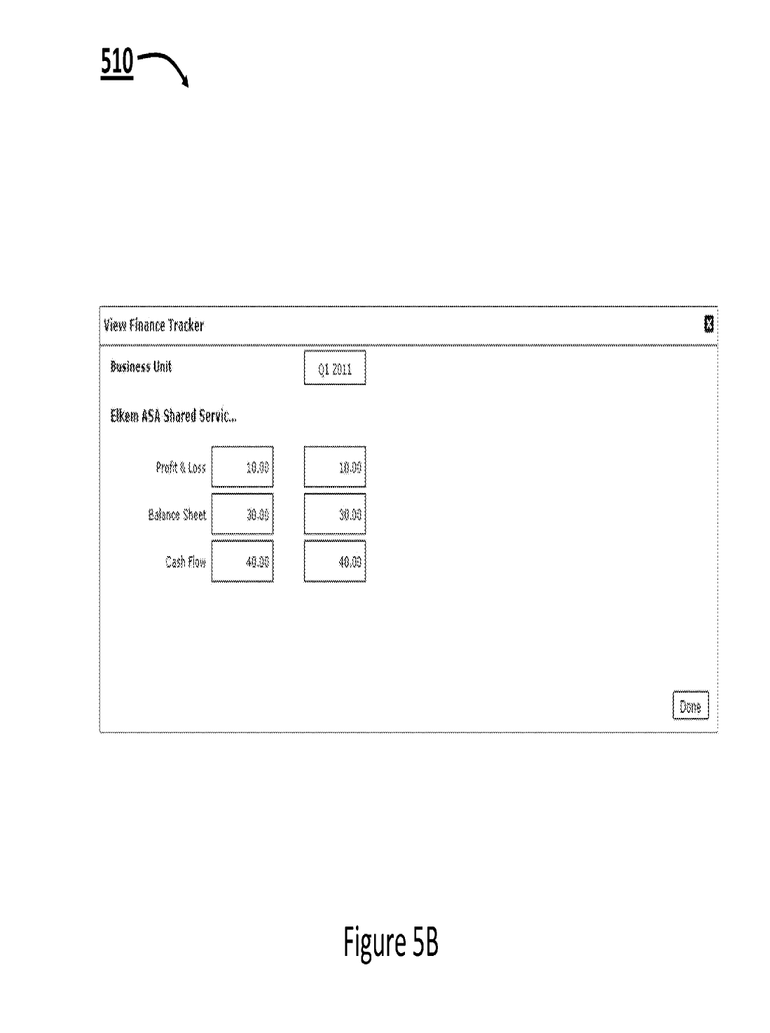

An exemplary computer screenshot 500 illustrating cost saving analysis according to an embodiment of the present invention is shown in FIG. 5A. In this screenshot, the scenario described above in Example 1 is used. Further, an exemplary computer screenshot 510 illustrating certain way of accounting for different components of the cost saving for this example is shown in FIG. 5B.

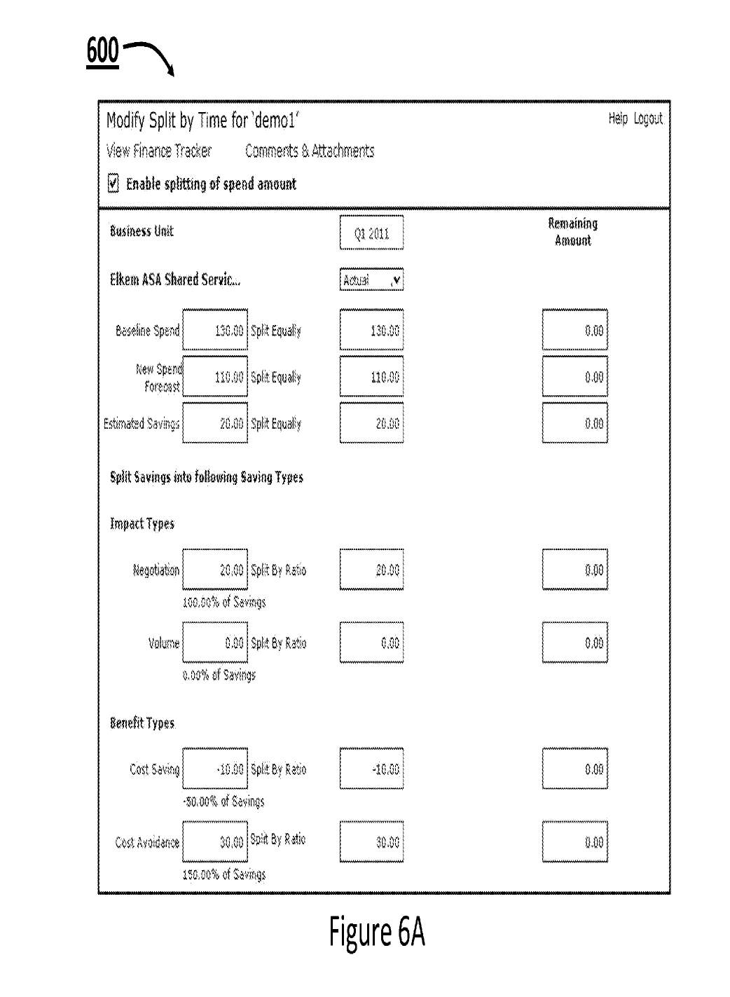

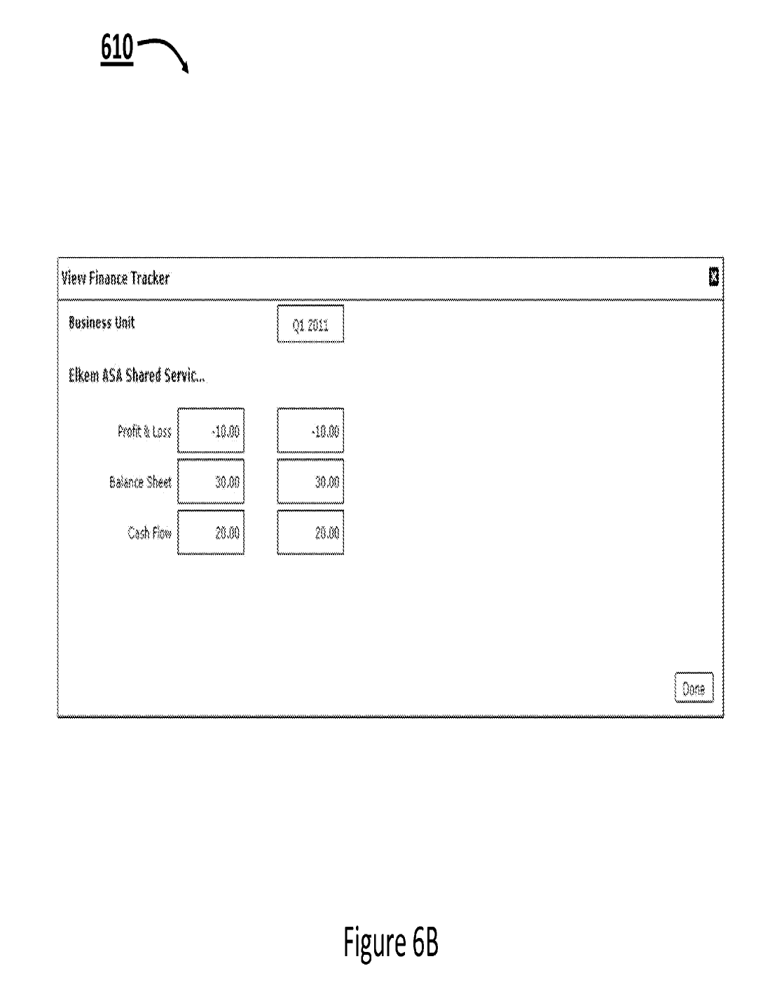

Another exemplary computer screenshot 600 illustrating cost saving analysis according to an embodiment of the present invention is shown in FIG. 6A. In this screenshot, the scenario described above in Example 2 is used. Further, an exemplary computer screenshot 610 illustrating certain way of accounting for different components of the cost saving for this example is shown in FIG. 6B.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A computer based system for tracking cost saving in a procurement process, wherein there is an interconnection of at least one configurable and namable business process element, comprising:
a host computer system including a computer processor unit;
a display device operably associated with the computer processor unit;
a communication interface for accessing the host computer system from a plurality of remote input/output devices to manage analysis of the cost saving of the procurement process; and
a computer readable medium operably associated with the computer processor unit, the computer readable medium storing instructions executable by the computer processor unit to perform the steps of:
receiving an input identifying a stage within a procurement process for a selected goods or service item;
receiving an input associated with baseline cost information for the selected item;
receiving an input associated with purchase price information for the selected item;
identifying a plurality of components for cost saving;
computing the plurality of the components for the cost saving, based at least upon the baseline cost information and the purchase cost information; and
transferring an indication of the computed plurality of the components for the cost saving;
wherein the indication of the computed plurality of the components for the cost saving corresponds to a performance level of a procurement department that executes the procurement process;
wherein the plurality of the components for the cost saving includes a plurality of benefit type components;
wherein the plurality of the benefit type components includes a cost reduction component and a cost avoidance component;
wherein the plurality of the components of the cost saving includes a plurality of impact type components that are indicative of a plurality of reasons for the cost saving;
wherein the plurality of the impact type components includes a cost saving component due to a decrease in quantity and a cost saving component due to a decrease in price, wherein the cost saving component due to a decrease in price corresponds to a negotiation by the procurement department of a lower price for the selected item.

2. The system of claim 1, wherein the transferring of the indication of the plurality of the components for the cost saving comprises transferring the indication to the display device.

3. The system claim 1, wherein the transferring of the indication of the plurality of the components for the cost saving comprises transferring the indication to a computer based financial accounting system for incorporation in financial accounts.

4. The system of claim 1, wherein the computing of any of the plurality of the components for the cost saving utilizes a pre-configured formula for that component.

5. The system of claim 1, wherein the plurality of the components for the cost saving relates to a plurality of heads in the financial accounts.

6. The system of claim 1, wherein the stage within the procurement process comprises a stage selected from the group consisting of a forecast stage, a negotiation stage, a contract stage, and a purchase stage.

7. A computer implemented method for tracking cost saving in a procurement process, wherein there is an interconnection of at least one configurable and namable business process element, comprising:
providing a host computer system including a computer processor unit;
providing a display device operably associated with the computer processor unit;
providing a communication interface for accessing the host computer system from a plurality of remote input/output devices to manage analysis of the cost saving of the procurement process;
providing a display device operably associated with the computer processor unit;
providing a computer readable medium operably associated with the computer processor unit, the computer readable medium storing instructions executable by the computer processor unit to perform the steps of:
receiving an input identifying a stage within a procurement process for a selected goods or service item;
receiving an input associated with baseline cost information for the selected item;
receiving an input associated with purchase price information for the selected item;
identifying a plurality of components for cost saving;
computing the plurality of the components for the cost saving, based at least upon the baseline cost information and the purchase cost information; and
transferring an indication of the computed plurality of the components for the cost saving;
wherein the indication of the computed plurality of the components for the cost saving corresponds to a performance level of a procurement department that executes the procurement process;
wherein the plurality of the components for the cost saving includes a plurality of benefit type components;
wherein the plurality of the benefit type components includes a cost reduction component and a cost avoidance component;
wherein the plurality of the components of the cost saving includes a plurality of impact type components that are indicative of a plurality of reasons for the cost saving;
wherein the plurality of the impact type components includes a cost saving component due to a decrease in quantity and a cost saving component due to a decrease in price.

8. The method of claim 7, wherein the transferring of the indication of the plurality of the components for the cost saving comprise transferring the indication to the display device.

9. The method of claim 7, wherein the transferring of the indication of the plurality of the components for the cost saving comprise transferring the indication to a computer based financial accounting system, wherein the plurality of the components for the cost saving relates to a plurality of heads in the financial accounts.

10. The method of claim 7, wherein the stage within the procurement process comprises a stage selected from the group consisting of a forecast stage, a negotiation stage, a contract stage, and a purchase stage.

11. A computer based system for tracking cost saving in a procurement process, wherein there is an interconnection of at least one configurable and namable business process element, comprising:
a host computer system including a computer processor unit;
a display device operably associated with the computer processor unit;
a communication interface for accessing the host computer system from a plurality of remote input/output devices to manage analysis of the cost saving of the procurement process; and
a computer readable medium operably associated with the computer processor unit, the computer readable medium storing instructions executable by the computer processor unit to perform the steps of:
receiving an input identifying a stage within a procurement process for a selected goods or service item;
receiving an input associated with baseline cost information for the selected item;
receiving an input associated with purchase price information for the selected item;
identifying a plurality of components for cost saving;
computing the plurality of the components for the cost saving, based at least upon the baseline cost information and the purchase cost information; and
transferring an indication of the computed plurality of the components for the cost saving;
wherein the indication of the computed plurality of the components for the cost saving corresponds to a performance level of a procurement department that executes the procurement process;
wherein the plurality of the components for the cost saving includes a plurality of benefit type components;
wherein the plurality of the benefit type components includes a cost reduction component and a cost avoidance component;
wherein the plurality of the components of the cost saving includes a plurality of impact type components that are indicative of a plurality of reasons for the cost saving;
wherein the plurality of the impact type components includes a cost saving component due to a decrease in quantity and a cost saving component due to a decrease in price, wherein the cost saving component due to a decrease in price corresponds to a negotiation by the procurement department of a lower price for the selected item;
wherein the transferring of the indication of the plurality of the components for the cost saving comprises transferring the indication to the display device.

12. A computer implemented method for tracking cost saving in a procurement process, wherein there is an interconnection of at least one configurable and namable business process element, comprising:
providing a host computer system including a computer processor unit;
providing a display device operably associated with the computer processor unit;
providing a communication interface for accessing the host computer system from a plurality of remote input/output devices to manage analysis of the cost saving of the procurement process; and
providing a computer readable medium operably associated with the computer processor unit, the computer readable medium storing instructions executable by the computer processor unit to perform the steps of:
receiving an input identifying a stage within a procurement process for a selected goods or service item;
receiving an input associated with baseline cost information for the selected item;
receiving an input associated with purchase price information for the selected item;
identifying a plurality of components for cost saving;
computing the plurality of the components for the cost saving, based at least upon the baseline cost information and the purchase cost information; and
transferring an indication of the computed plurality of the components for the cost saving;
wherein the indication of the computed plurality of the components for the cost saving corresponds to a performance level of a procurement department that executes the procurement process;
wherein the plurality of the components for the cost saving includes a plurality of benefit type components;
wherein the plurality of the benefit type components includes a cost reduction component and a cost avoidance component;
wherein the plurality of the components of the cost saving includes a plurality of impact type components that are indicative of a plurality reasons for the cost saving;
wherein the plurality of the impact type components includes a cost saving component due to a decrease in quantity and a cost saving component due to a decrease in price, wherein the cost saving component due to a decrease in price corresponds to a negotiation by the procurement department of a lower price for the selected item;
wherein the transferring of the indication of the plurality of the components for the cost saving comprises transferring the indication to the display device.

13. A system for analysis of cost saving in a procurement process, wherein there is an interconnection of at least one configurable and namable business process element, comprising:
a host computer system;
at least one database component associated with the host computer system;
a communication interface for accessing the host computer system from a plurality of remote input/output devices to manage analysis of cost saving in a procurement process, wherein the business process element includes:
receiving an input through an input/output system;
identifying a stage or transaction tracking within the procurement process for a selected good or service item on a web based form;
receiving an input associated with baseline cost information for the selected item based on the integration of the system with a spend analysis system;
receiving an input associated with purchase price information for the selected item for a procurement stage based on an integration of a procurement system;
identifying a plurality of components for cost saving;
computing the plurality of the components for the cost saving, based at least upon the baseline cost information and purchase cost information; and
flipping of the web based form containing baseline information and purchase information for the procurement stage into an electronic report including a cost saving analysis transferring an indication of a computed plurality of the components for the cost saving;
wherein a plurality of benefit type components includes a cost reduction component;
wherein the plurality of the components of the cost saving includes a plurality of impact type components that are indicative of a plurality of reasons for the cost saving;
wherein the plurality of the impact type components includes a cost saving component due to a decrease in quantity and a cost saving component due to a decrease in price that are indicative of a plurality of reasons for the cost saving;
wherein the plurality of the components for the cost saving includes a plurality of benefit type components;
wherein the plurality of the components of the cost saving include a plurality of impact type components that are indicative of a plurality of reasons for the cost saving;
wherein the plurality of the impact type components include a cost saving component due to a decrease in quantity and a cost saving component due to a decrease in price;
wherein the cost saving component due to a decrease in price corresponds to a negotiation by the procurement department of a lower price for the selected item.
